(19) United States
(12) Patent Application Publication
(10) Pub. No.: US 2003/0232675 A1
(43) Pub. Date: Dec. 18, 2003

(54) Power transmission interruption apparatus

(75) Inventors: Terufumi Miyazaki, Toyota-shi (JP); Yoshihiro Iijima, Seto-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 10/453,632

(22) Filed: Jun. 4, 2003

(30) Foreign Application Priority Data
Jun. 18, 2002 (JP) 2002-177505

(51) Int. Cl. F16H 59/00; F16H 63/00; F16H 61/00

(52) U.S. Cl. 474/18; 474/28

(57) ABSTRACT

A power transmission interruption apparatus transmits and interrupts power between an input shaft as a rotation member and a second rotation element, and between the input shaft and a fourth rotation element using a first clutch and a second clutch. In the power transmission interruption apparatus, a centrifugal hydraulic pressure canceller chamber of a first hydraulic cylinder is formed using, as a cancel plate, a cylinder tube of a second hydraulic cylinder, which causes the second clutch to be engaged. Therefore, as compared with a case where the cancel plate is separately provided, the number of components decreases, which reduces the weight and manufacturing cost. In addition, a linear dimension in the direction of the axis is shortened, which makes the configuration compact.

The disclosure of Japanese Patent Application No. 2002-177505 filed on Jun. 18, 2002, including the specification, drawings and abstract, is incorporated herein by reference in its entirety.

### BACKGROUND OF THE INVENTION

1. Field of the Invention

The invention relates to a power transmission interruption apparatus, and more particularly to improvement in a power transmission interruption apparatus in which a pair of hydraulic cylinders that causes a pair of friction engaging devices to be engaged is provided on a common rotation member so as to be integrally rotated around an axis.

b 2. Description of the Related Art

An automatic transmission for a vehicle using plural planetary gears, clutches, and brakes is frequently employed. An example of such an automatic transmission is disclosed in Japanese Patent Laid-Open Publication No. 2001-304355.

The transmission includes (a) a rotation member (an input shaft 2), (b) a first hydraulic cylinder, (c) a first friction engaging device (a clutch C2), (d) a second hydraulic cylinder, and (e) a second friction engaging device (a clutch C3).

(a) The rotation member (the input shaft 2) rotates around an axis.

(b) The first hydraulic cylinder is provided coaxially and integrally with the rotation member in (a), and is rotated around the axis of the rotation member in (a). In addition, the first hydraulic cylinder moves a piston (15) in a first direction which is in parallel with the axis when hydraulic fluid is supplied into a pressure chamber.

(c) The first friction engaging device (the clutch C2) includes plural friction members provided on both of the rotation member and a first connecting member (4b) that are rotatable with respect to each other around the axis. The plural friction members provided on the rotation member are non-rotatable with respect thereto. Also, the plural friction members provided on the first connecting member (4b) are non-rotatable with respect thereto. The first friction engaging device (the clutch C2) connects the rotation member and the first connecting member when the piston of the first hydraulic cylinder is moved in the first direction such that the friction members are engaged.

(d) The second hydraulic cylinder is provided coaxially and integrally with the rotation member at a position adjacent to the first hydraulic cylinder in the first direction, and is rotated around the axis. In addition, the second hydraulic cylinder moves a piston (31) when hydraulic fluid is supplied into a pressure chamber.

(e) The second friction engaging device (the clutch C3) includes plural friction members provided on the rotation member and a second connecting member (an intermediate shaft 3) that are rotatable with respect to each other around the axis. The friction members provided on the rotation member are non-rotatable thereto. Also, the friction members provided on the second connecting member are non-rotatable with respect thereto. The second friction engaging device (the clutch C3) connects the rotation member and the second connecting member when a piston of the second hydraulic cylinder is moved such that the friction members are engaged.

A cancel plate (21, 34) is provided in each of the first hydraulic cylinder and the second hydraulic cylinder such that centrifugal hydraulic pressure due to the rotation of the hydraulic cylinders is cancelled.

However, in the case where the cancel plate is provided in each of the hydraulic cylinders such that the centrifugal hydraulic pressure is cancelled in this manner, the number of components increases, which increases the weight and manufacturing cost. In addition, a linear dimension in the axial direction increases, which increases an arrangement space.

### SUMMARY OF THE INVENTION

In view of the above, it is an object of the invention to configure a power transmission interruption apparatus in which a pair of hydraulic cylinders is provided in a common rotation member so as to be integrally rotated around an axis, and which is compact, light-weight, and inexpensive.

In other words, according to an aspect of the invention, a power transmission interruption apparatus which integrally rotates so as to transmit power includes a rotation member, a first friction engaging device and a second friction engaging device, a first hydraulic cylinder, a second hydraulic cylinder, and a centrifugal hydraulic pressure canceller chamber. The first friction engaging device and the second friction engaging device transmit power. The first hydraulic cylinder is provided coaxially with the rotation member. The first hydraulic cylinder rotates together with the power transmission interruption apparatus, and causes the first friction engaging device to be engaged. The second hydraulic cylinder is provided coaxially with the rotation member and is provided next to the first hydraulic cylinder along to a rotation axis of the rotation member. The second hydraulic cylinder rotates together with the power transmission interruption apparatus, and causes the second friction engaging device to be engaged. The centrifugal hydraulic pressure canceller chamber is formed between a cylinder tube of the second hydraulic cylinder and a piston of the first hydraulic cylinder using the cylinder tube as a cancel plate. The centrifugal hydraulic pressure canceller chamber cancels centrifugal hydraulic pressure in the first hydraulic cylinder, which is generated when hydraulic fluid is introduced into the first hydraulic cylinder.

Also, according to another aspect of the invention, a power transmission interruption apparatus includes a rotation member, a first hydraulic cylinder, a first friction engaging device, a second hydraulic cylinder, a second friction engaging device, and a centrifugal hydraulic pressure canceller chamber. The rotation member is rotated around an axis. The first hydraulic cylinder is provided coaxially and integrally with the rotation member and is rotated around the axis. In addition, the first hydraulic cylinder moves a piston in a first direction which is in parallel with the axis when hydraulic fluid is supplied into a pressure chamber. The first friction engaging device includes at least one friction member provided on each of the rotation member and a first connecting member that are rotatable with respect to each other around the axis. The at least one friction member provided on the rotation member is non-rotatable with respect thereto. The at least one friction member provided on the first connecting member is non-rotatable with respect thereto. The first friction engaging device connects the rotation member and the first connecting member when the piston of the first hydraulic cylinder is moved in the first direction such that the at least one friction member on the rotation member and the at least one friction member on the first connecting member are engaged. The second hydraulic cylinder is provided coaxially and integrally with the rotation member at a position adjacent to the first hydraulic cylinder in the first direction, and is rotated around the axis. In addition, the second hydraulic cylinder moves a piston when hydraulic fluid is supplied into a pressure chamber. The second friction engaging device includes at least one friction member provided on each of the rotation member and a second connecting member that are rotatable with respect to each other around the axis. The at least one friction member provided on the rotation member is non-rotatable with respect thereto. The at least one friction member provided on the second connecting member is non-rotatable with respect thereto. The second friction engaging device connects the rotation member and the second connecting member when a piston of the second hydraulic cylinder is moved such that the friction members are engaged. The centrifugal hydraulic pressure canceller chamber is formed between a cylinder tube forming a pressure chamber of the second hydraulic cylinder and the piston of the first hydraulic cylinder using the cylinder tube as a cancel plate. The centrifugal hydraulic pressure canceller chamber cancels centrifugal hydraulic pressure in a pressure chamber of the first hydraulic cylinder, which is generated when hydraulic fluid is introduced into the pressure chamber of the first hydraulic cylinder. The power transmission interruption apparatus transmits and interrupts power between the rotation member and the first connecting member, and between the rotation member and the second connecting member.

### BRIEF DESCRIPTION OF THE DRAWINGS

FIG. 1A is a schematic diagram showing an automatic transmission for a vehicle including a power transmission interruption apparatus according to an embodiment of the invention, and FIG. 1B is an operation table showing operation states of clutches and brakes when achieving each shift stage of the automatic transmission for a vehicle;

FIG. 2 is a collinear diagram concerning the embodiment in FIG. 1;

FIG. 3 is a cross sectional view specifically showing clutches C1, C2 of the automatic transmission for a vehicle in FIG. 1; and

FIG. 4 is a cross sectional view showing another embodiment of the invention.

### DETAILED DESCRIPTION OF THE PREFERRED EMBODIMENTS

Hereinafter, an embodiment of the invention will be described in detail with reference to accompanying drawings.

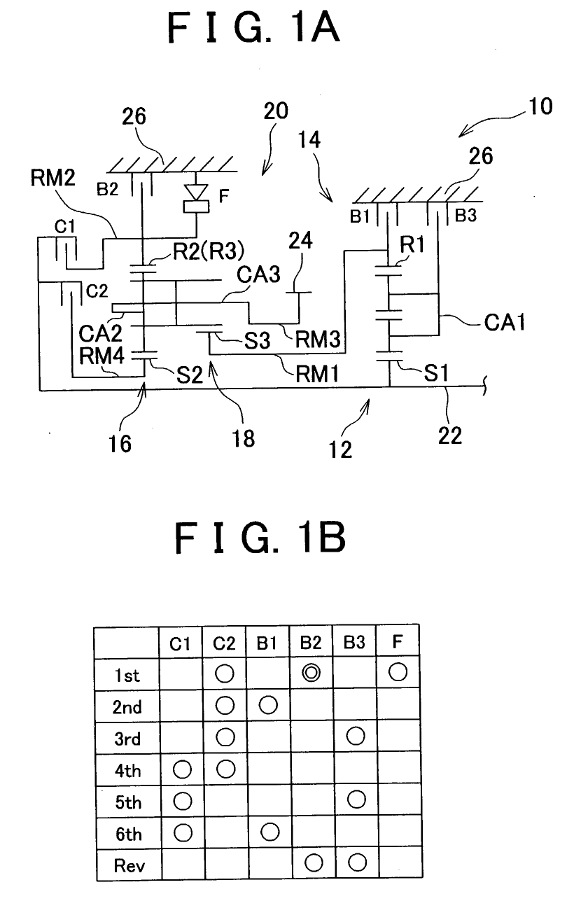

FIG. 1A is a schematic diagram showing an automatic transmission for a vehicle 10 to which the invention is applied. FIG. 1B is an operation table describing engagement elements when achieving plural shift stages. The automatic transmission for a vehicle 10 is of transversely-mounted type, and is mounted in a front engine front wheel drive vehicle and the like. The automatic transmission for a vehicle 10 includes a first shift portion 14 and a second shift portion 20 on the same axis. The automatic transmission for a vehicle 10 changes the rotational speed of an input shaft 22 and outputs the changed rotational speed from an output gear 24. The first shift portion 14 is configured so as to include a first planetary gear device 12 of double pinion type as a main portion. Also, the second shift portion 20 is configured so as to include a second planetary gear device 16 of single pinion type and a third planetary gear device 18 of double pinion type as main portions. The input shaft 22 corresponds to an input member, for example, a turbine shaft of a torque converter which is rotationally driven by a driving power source for running such as an engine.

The automatic transmission for a vehicle 10 is configured so as to be substantially symmetrical with respect to an axis. In FIG. 1A, a lower half portion below the axis is omitted.

The first planetary gear device 12 constituting the first shift portion 14 includes three rotation elements, that is, a sun gear S1, a carrier CA1, and a ring gear R1. In the first planetary gear device 12, when the sun gear S1 is connected to the input shaft 22 so as to be rotationally driven, and the carrier CA1 is fixed to a case 26 so as to be non-rotatable through a third brake B3, the rotational speed of the ring gear R1 as an intermediate output member is reduced with respect to the rotational speed of the input shaft 22 so as to be output. Also, portions of the second planetary gear device 16 and the third planetary gear device 18 which constitute the second shift portion 20 are mutually connected such that four rotation elements RM1 to RM4 are formed. More specifically, a sun gear S3 of the third planetary gear device constitutes the first rotation element RM1. Also, a ring gear R2 of the second planetary gear device 16 and a ring gear R3 of the third planetary gear device 18 are mutually connected so as to constitute the second rotation element RM2. Further, a carrier CA2 of the second planetary gear device 16 and a carrier CA3 of the third planetary gear device 18 are mutually connected so as to constitute the third rotation element RM3. Furthermore, a sun gear S2 of the second planetary gear device 16 constitutes the fourth rotation element RM4. The second planetary gear device 16 and the third planetary gear device 18 form a Ravigneaux type gear train, in which the carriers CA2, CA3 are constituted by a common member, the ring gears R2 and R3 are constituted by a common member, and a pinion gear of the second planetary gear device 16 is also used as a second pinion gear of the third planetary gear device 18.

The first rotation element RM1 (the sun gear S3) is selectively connected to the case 26 by a first brake B1 such that the rotation thereof is stopped. The second rotation element RM2 (the ring gears R2, R3) is connected to the input shaft 22 through a first clutch C1, and is selectively fixed to the case 26 by a second brake B2 such that the rotation thereof is stopped. The fourth rotation element RM4 (the sun gear S2) is selectively connected to the input shaft 22 through the second clutch C2. The first rotation element RM1 (the sun gear S3) is integrally connected to the ring gear R1 of the first planetary gear device 12, which is an intermediate output member. The third rotation element RM3 (the carriers CA2, CA3) is integrally connected to the output gear 24 so as to output the rotation. Each of the first brake B1 to the third brake B3, the first clutch C1 as the first friction engaging device, and the second clutch C2 as the second friction engaging device is a multi-plate type hydraulic friction engaging device which is frictionally engaged by the hydraulic cylinder. A one way clutch F is provided between the second rotation element RM2 and the case 26 so as to be in parallel with the second brake B2. The one way clutch F permits the clockwise rotation (that is, the rotation whose direction is the same as that of the rotation of the input shaft 22), and prevents the reverse rotation of the second rotation element RM2.

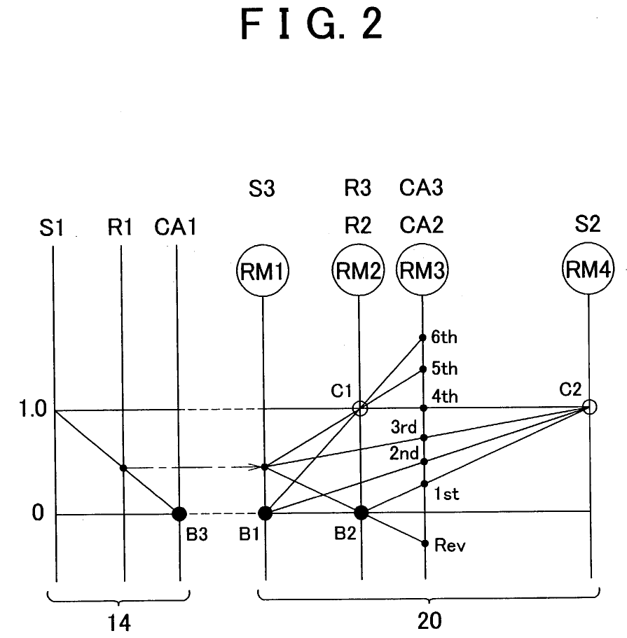

FIG. 2 is a collinear diagram showing the rotational speeds of the rotation elements of the first shift portion 14 and the second shift portion 20 using straight lines. A lower horizontal line indicates the rotational speed “0”, and an upper horizontal line indicates the rotational speed “1.0”, that is, the same rotational speed as that of the input shaft 22. Also, vertical lines concerning the first shift portion 14 indicate the sun gear S1, the ring gear R1, and the carrier CA1 from the left side. The intervals therebetween are determined according to a gear ratio ρ1 of the first planetary gear device 12 (that is, the number of the teeth of the sun gear/the number of the teeth of the ring gear). Four vertical lines concerning the second shift portion 20 indicate the first rotation element RM1 (the sun gear S3), the second rotation element RM2 (the ring gears R2, R3), the third rotation element RM3 (the carriers CA2, CA3), and the fourth rotation element RM4 (the sun gear S2) from the left side toward the right side. The intervals therebetween are determined according to a gear ratio ρ2 of the second planetary gear device 16 and a gear ratio ρ3 of the third planetary gear device 18.

As apparent from the above collinear diagram, when the second clutch C2 and the second brake B2 are engaged, the fourth rotation element RM4 is integrally rotated with the input shaft 22, and the rotation of the second rotation element RM2 is stopped, the third rotation element RM3 connected to the output gear 24 is rotated at a first rotational speed. Thus, a first shift stage whose shift ratio is the largest is achieved. When the second clutch C2 and the first brake B1 are engaged, the fourth rotation element RM4 is integrally rotated with the input shaft 22, and the rotation of the first rotation element RM1 is stopped, the third rotation element RM3 is rotated at a second rotational speed. Thus, a second shift stage whose shift ratio is smaller than that of the first shift stage is achieved. When the second clutch C2 and the third brake B3 are engaged, the fourth rotation element RM4 is integrally rotated with the input shaft 22, and the rotation of the first rotation element RM1 is reduced through the first shift portion 14, the third rotation element RM3 is rotated at a third rotational speed. Thus, a third shift stage whose shift ratio is smaller than that of the second shift stage is achieved. When the first clutch C1 and the second clutch C2 are engaged, and the second shift portion 20 is integrally rotated with the input shaft 22, the third rotation element RM3 is rotated at a fourth rotational speed, that is the same rotational speed as that of the input shaft 22. Thus, a fourth shift stage whose shift ratio is smaller than that of the third shift stage is achieved. The shift ratio of the fourth shift stage is 1. When the first clutch C1 and the third brake B3 are engaged, the second rotation element RM2 is integrally rotated with the input shaft 22, and the first rotation element RM1 is rotated at a reduced rotational speed through the first shift portion 14, the third rotation element RM3 is rotated at a fifth rotational speed. Thus, a fifth shift stage whose shift ratio is smaller than that of the fourth shift stage is achieved. When the first clutch C1 and the first brake B1 are engaged, the second rotation element RM2 is integrally rotated with the input shaft 22, and the rotation of the first rotation element RM1 is stopped, the third rotation element RM3 is rotated at a sixth rotational speed. Thus, a sixth shift stage whose shift ratio is smaller than that of the fifth shift stage is achieved. Also, when the second brake B2 and the third brake B3 are engaged, the rotation of the second rotation element RM2 is stopped, and the first rotation element RM1 is rotated at a reduced speed through the first shift portion 14. Thus, the third rotation element RM3 is reversely rotated at a rotational speed Rev. Thus, a reverse shift stage Rev is achieved.

FIG. 1B is an operation table showing the relation between the shift stages and the operation states of the clutches C1, C2, and the brakes B1 to B3. In the operation table, a circle indicates engagement, and a double circle indicates engagement which is performed only at the time of engine brake. Since the one way clutch F is provided in parallel with the brake B2 for achieving the fist shift stage, the brake B2 does not necessarily need to be engaged at the time of take-off (at the time of acceleration). Also, the shift ratios of the shift stages are appropriately determined according to the gear ratios ρ1, ρ2, and ρ3 of the first planetary gear device 12, the second planetary gear device 16, and the third planetary gear device 18.

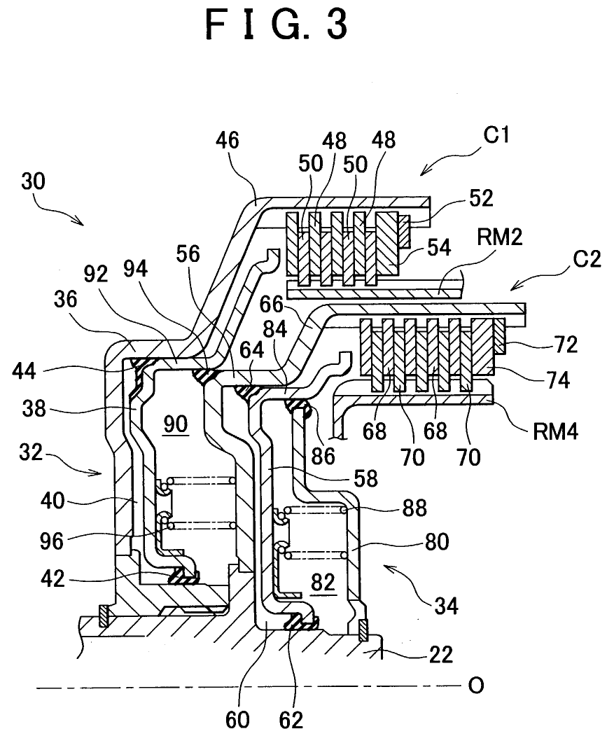

Meanwhile, FIG. 3 is a cross sectional view specifically showing a power transmission interruption apparatus 30 which transmits and interrupts power between the input shaft 22 which is the rotation member and the second rotation element RM2 which is the first connecting member, and between the input shaft 22 and the fourth rotation element RM4 which is the second connecting member. FIG. 3 shows an upper half portion above the axis O. The power transmission interruption apparatus 30 includes a first hydraulic cylinder 32 which causes the first clutch C1 to be frictionally engaged, and a second hydraulic cylinder 34 which causes the second clutch C2 to be frictionally engaged. Each of the first hydraulic cylinder 32 and the second hydraulic cylinder 34 has an annular shape with the input shaft 22 at the center thereof, and is provided coaxially and integrally with the input shaft 22 so as to be integrally rotated around the axis O together with the input shaft 22. The first hydraulic cylinder 32 corresponds to the first hydraulic cylinder in the first aspect of the invention, and the second hydraulic cylinder 34 corresponds to the second hydraulic cylinder in the first aspect of the invention.

The first hydraulic cylinder 32 includes a cylinder tube 36 and a piston 38. The cylinder tube 36 has a bottomed cylindrical shape and opens toward the right side in FIG. 3. The cylinder tube 36 is provided so as to be non-rotatable with respect to the input shaft 22 and non-movable in the direction of the axis O (in the lateral direction in FIG. 3). The piston 38 is fitted in the cylinder tube 36 so as to be movable in the direction of the axis O.

When hydraulic fluid is supplied to a pressure chamber 40 between the cylinder tube 36 and the piston 38, the piston 38 is moved in a first direction, that is, to the right side in FIG. 3 such that the first clutch C1 is frictionally engaged. Sealing members 42, 44 made of rubber or the like are fixed to an inner peripheral portion and an outer peripheral portion of the piston 38 respectively so as to fluid-tightly seal the pressure chamber 40.

Also, the first clutch C1 includes a drum 46, plural friction members 48, and plural friction members 50. The drum 46 is provided so as to be continuous to, and integral with an outer cylinder portion of the cylinder tube 36. The plural friction members 48 are provided on the drum 46 so as to be non-rotatable with respect thereto. The plural friction members 50 are provided on the second rotation element RM2 so as to be non-rotatable with respect thereto. Each of the friction members 48 and each of the friction members 50 are arranged alternately.

When the friction members 48, 50 are pressed so as to be frictionally engaged between the piston 38 and a pressing plate 54 which is positioned by a stopper 52 (a snap ring or the like) provided at an end portion of the drum 46, the second rotation element RM2 is integrally connected with the input shaft 22.

A second hydraulic cylinder 34 is provided so as to be adjacent to the first hydraulic cylinder 32 in the first direction (on the right side in FIG. 3).

The second hydraulic cylinder 34 includes a cylinder tube 56 and a piston 58. The cylinder tube 56 has bottomed cylindrical shape, and opens toward the right side in FIG. 3. The cylinder tube 56 is provided so as to be non-rotatable with respect to the input shaft 22 and non-movable in the direction of the axis O. The piston 58 is fitted in the cylinder tube 56 so as to be movable in the direction of the axis O. When hydraulic fluid is supplied to a pressure chamber 60 between the cylinder tube 56 and the piston 58, the second hydraulic cylinder 34 moves the piston 58 in a second direction which is the same direction as the first direction, that is, to the right side in FIG. 3 such that the second clutch C2 is frictionally engaged.

Sealing members 62, 64 made of rubber or the like are fixed to an inner peripheral portion and an outer peripheral portion of the piston 58 respectively so as to fluid-tightly seal the pressure chamber 60.

Also, the second clutch C2 includes a drum 66, plural friction members 68, and plural friction members 70. The drum 66 is provided so as to be continuous to, and integral with an outer cylinder of the cylinder tube 56. The plural friction members 68 are provided on the drum 66 so as to be non-rotatable with respect thereto. The plural friction members 70 are provided on the fourth rotation member RM4 so as to be non-rotatable with respect thereto. Each of the friction members 68 and each of the friction members 70 are arranged alternately.

In the case of the second clutch C2, the friction members 68, 70 are pressed so as to be frictionally engaged between the piston 58 and a pressing plate 74 positioned by a stopper 72 (a snap ring or the like) provided at an end portion of the drum 66. When the friction member 68, 70 are frictionally engaged in this manner, the fourth rotation element RM4 is integrally connected with the input shaft 22. The second clutch C2 has a diameter smaller than that of the first clutch C1, and is provided so as to partly overlap the first clutch C1 in the direction of the axis O.

The second hydraulic cylinder 34 also includes a cancel plate 80 which is provided integrally with the input shaft 22. In the second hydraulic cylinder 34, a centrifugal hydraulic pressure canceller chamber 82 is formed between the cancel plate 80 and the piston 58. The centrifugal hydraulic pressure canceller chamber 82 is provided so as to be opposed to the pressure chamber 60 with the piston 58 therebetween. The centrifugal hydraulic pressure canceller chamber 82 cancels the centrifugal hydraulic pressure generated in the pressure chamber 60 due to the rotation around the axis O when the hydraulic fluid is introduced into the pressure chamber 60 from a fluid passage (not shown) provided in an inner peripheral portion of the input shaft 22 and the like. The piston 58 includes an outer cylinder 84 which has a cylindrical shape. A sealing member 86 made of rubber or the like is fixed to an outer peripheral edge of the cancel plate 80 so as to be slidably contact an inner peripheral surface of the outer cylinder portion 84. The sealing member 86 fluid-tightly seals between an outer peripheral surface of the cancel plate 80 and the inner peripheral surface of the outer cylinder portion 84 while permitting the piston 58 to move. A return spring 88 is provided in the centrifugal hydraulic pressure canceller chamber 82. When the hydraulic pressure in the pressure chamber 60 is reduced, the return spring 88 causes the piston 58 to retreat to the left side in FIG. 3 such that the second clutch C2 is disengaged.

Also, in the first hydraulic cylinder 32, a centrifugal hydraulic canceller chamber 90 is formed between the cylinder tube 56 of the second hydraulic cylinder 34 and the piston 38 using the cylinder tube 56 as a cancel plate. The centrifugal hydraulic canceller chamber 90 is opposed to the pressure chamber 40 with the piston 38 therebetween. The centrifugal hydraulic pressure canceller chamber 90 cancels the centrifugal hydraulic pressure generated in the pressure chamber 40 due to the rotation around the axis O when the hydraulic fluid is introduced into the pressure chamber 40 from a fluid passage (not shown) provided in an inner peripheral portion of the input shaft 22 and the like. The piston 38 includes an outer cylinder portion 92 which has a cylindrical shape and which is fitted to an outer peripheral side of the cylinder tube 56. A sealing member 94 made of rubber or the like is fixed to the outer peripheral portion of the cylinder tube 56 so as to slidably contact an inner peripheral surface of the outer cylinder portion 92. The sealing member 94 fluid-tightly seals between an outer peripheral surface of the cylinder tube 56 and the inner peripheral surface of the outer cylinder portion 92 while permitting the piston 38 to move. A return spring 96 is provided in the centrifugal hydraulic pressure canceller 90. When the hydraulic pressure in the pressure chamber 40 is reduced, the return spring 96 causes the piston 38 to retreat to the left side in FIG. 3 such that the first clutch C1 is disengaged. The outer cylinder portion 92 corresponds to a fitting portion.

The cylinder tube 36 and the piston 38 of the first hydraulic cylinder 32, and the cylinder tube 56, the piston 58, and the cancel plate 80 of the second hydraulic cylinder 34 are all formed by performing drawing processing or the like on a metal plate using a press.

In the power transmission interruption apparatus 30 according to the embodiment, the cylinder tube 56 of the second hydraulic cylinder 34 is used as the cancel plate, and forms the centrifugal hydraulic canceller chamber 90 of the first hydraulic cylinder 34. Thus, as compared with the case where the cancel plate is separately provided, the number of components decreases, which reduces the weight and manufacturing cost. In addition, a linear dimension in the direction of the axis O is shortened, which makes the configuration compact.

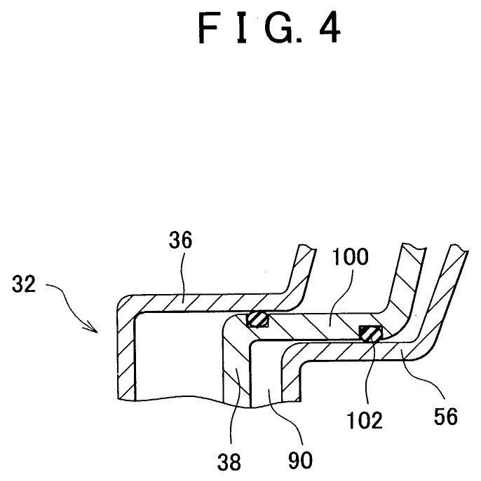

In the embodiment, the sealing member 94 is fixed to the cylinder tube 56 of the second hydraulic cylinder 34. However, as shown in FIG. 4, a fitting portion 100 which is fitted to an outer peripheral side of the cylinder tube 56 may be provided on the piston 38 of the first hydraulic cylinder 32, an annular groove may be formed in an inner peripheral surface of the fitting portion 100, and an O-ring 102 may be fitted therein such that the O-ring 102 fluid-tightly seals between the fitting portion 100 and the outer peripheral surface of the cylinder tube 56. The O-ring 102 corresponds to the sealing member.

In the power transmission interruption apparatus according to the embodiment, for example, each of the first hydraulic cylinder 32, the second hydraulic cylinder 34, and the first clutch C1 and the second clutch C2 as the friction engaging devices is configured to have an annular shape with the rotation member having a shaft shape at the center thereof. However, various configuration may be made, such as a configuration in which a hydraulic cylinder and a friction engaging device are provided inside a rotation member having a cylindrical shape, and a configuration in which the second hydraulic cylinder 34 includes a disc-shaped piston that does not have an opening portion at the center thereof.

Further, the pair of the friction engaging devices may have substantially the same diameter, and may be provided so as to be adjacent to each other in the axial direction. Alternatively, the pair of the friction engaging devices may be provided in substantially the same position in the axial direction such that one of the friction engaging devices is positioned on an inner peripheral side of the other.

It is preferable that the centrifugal hydraulic pressure canceller chamber should be provided in the second hydraulic cylinder 34. However, the centrifugal hydraulic canceller chamber in the second hydraulic cylinder 34 is not necessarily essential for realizing the invention.

It is preferable to use, as the friction engaging device, a multi plate type clutch and a multi plate type brake in which two or more friction members are provided on each of two members that are rotatable with respect to each other. However, a single plate type friction engaging device in which one friction member is provided on each member may be employed.

Power may be transmitted from the rotation member (the input shaft 22) to the first connecting member (the second rotation element RM2), and the second connecting member (the fourth rotation element RM4), or may be transmitted reversely. Alternatively, the direction in which power is transmitted may be switched according to a condition. The first connecting member (the second rotation element RM2) and the second connecting member (the fourth rotation element RM4) may rotate around the axis, or may be fixed to a housing or the like so as to be non-rotatable around the axis. Also, the first connecting member (the second rotation element RM2) and the second connecting member (the fourth rotation element RM4) may be separate from each other so as to be rotatable with respect to each other, or may be integrally connected to each other so as to rotate together.

The direction in which the piston 58 of the second hydraulic cylinder 34 is moved may be the same as the first direction, that is, the direction in which the piston 38 of the first hydraulic cylinder 32 is moved, or may be a direction opposite to the first direction.

According to an embodiment shown in FIG. 4, the piston 38 of the first hydraulic cylinder 32 is fitted to the outer peripheral side of the cylinder tube 56 of the second hydraulic cylinder 34. However, when the invention is realized in another embodiment, for example, the configuration may be such that the second hydraulic cylinder having an annular shape is provided inside a rotation member having a cylindrical shape, and the piston of the first hydraulic cylinder is fitted to the inner peripheral side of an inner cylinder of a cylinder tube having an annular shape.

According to the embodiment shown in FIG. 4, the fitting portion is provided on the piston 38 of the first hydraulic cylinder 32 so as to be fitted to the cylinder tube 56 of the second hydraulic cylinder 34. However, in the case where the piston of the first hydraulic cylinder protrudes in the direction opposite to the first direction, the cylinder tube of the first hydraulic cylinder and the cylinder tube of the second hydraulic cylinder may be integrally connected so as to form a centrifugal hydraulic pressure canceller chamber.

While the embodiments of the invention have been described in detail with reference to the accompanying drawings, the embodiments are only examples, and the invention can be realized in embodiments in which various changes and improvements are made based on the knowledge of those skilled in the art.

What is claimed is:

1. A power transmission interruption apparatus comprising:
a rotation member;
a first friction engaging device and a second friction engaging device which are able to transmit power;
a first hydraulic cylinder which is provided coaxially with the rotation member, and which rotates together with the rotation member, for causing the first friction engaging device to be engaged;
a second hydraulic cylinder which is provided coaxially with the rotation member, which is provided next to the first hydraulic cylinder along to a rotation axis of the rotation member, and which rotates together with the rotation member, for causing the second friction engaging device to be engaged; and
a centrifugal hydraulic pressure canceller chamber which is formed between a cylinder tube of the second hydraulic cylinder and a piston of the first hydraulic cylinder, wherein the cylinder tube comprises a cancel plate of said centrifugal hydraulic pressure canceller chamber, the centrifugal hydraulic pressure canceller chamber cancelling centrifugal hydraulic pressure in the first hydraulic cylinder, which is generated when hydraulic fluid is introduced into the first hydraulic cylinder.

2. A power transmission interruption apparatus comprising:
a rotation member which is rotatable around an axis;
a first hydraulic cylinder which is provided coaxially and integrally with the rotation member and is rotatable around the axis, and which is actuatable to move a piston in a first direction which is in parallel with the axis when hydraulic fluid is supplied into a pressure chamber of the first hydraulic cylinder;
a first friction engaging device which includes at least one friction member provided on each of the rotation member and a first connecting member, wherein the rotation member and the first connecting member are rotatable with respect to each other around the axis, the at least one friction member provided on the rotation member being non-rotatable with respect thereto and the at least one friction member provided on the first connecting member being non-rotatable with respect thereto, the first friction engaging device connecting the rotation member and the first connecting member when the piston of the first hydraulic cylinder is moved in the first direction such that the at least one friction member on the rotation member and the at least one friction member on the first connecting member are engaged;
a second hydraulic hydraulic cylinder which is provided coaxially and integrally with the rotation member at a position adjacent to the first hydraulic cylinder in the first direction, and is rotatable around the axis, and which is actuatable to move another piston when hydraulic fluid is supplied into a pressure chamber of the second hydraulic cylinder;
a second friction engaging device which includes at least one friction member provided on each of the rotation member and a second connecting member, wherein the rotation member and the second connecting member are rotatable with respect to each other around the axis, the at least one friction member provided on the rotation member being non-rotatable with respect thereto and the at least one friction member provided on the second connecting member being non-rotatable with respect thereto, the second engaging device connecting the rotation member and the second connecting member when a piston of the second hydraulic cylinder is moved such that the at least one friction member on the rotation member and the at least one friction member on the second connecting member are engaged; and
a centrifugal hydraulic pressure canceller chamber which is formed between a cylinder tube forming a pressure chamber of the second hydraulic cylinder and the piston of the first hydraulic cylinder, wherein the cylinder tube comprises a cancel plate of said centrifugal hydraulic pressure canceller chamber, the centrifugal hydraulic pressure canceller chamber cancelling centrifugal hydraulic pressure in a pressure chamber of the first hydraulic cylinder, which is generated when hydraulic fluid is introduced into the pressure chamber, wherein the power transmission interruption apparatus transmits and interrupts power between the rotation member and the first connecting member, and between the rotation member and the second connecting member.

3. The power transmission interruption apparatus according to claim 2, wherein the centrifugal hydraulic pressure canceller chamber is formed so as to include a fitting portion that is provided on the piston of the first hydraulic cylinder so as to be fitted to an outer peripheral side of the cylinder tube of the second hydraulic cylinder, wherein a sealing member that is provided in an outer peripheral portion of the cylinder tube fluid-tightly seals between an outer peripheral surface of the cylinder tube and an inner peripheral surface of the fitting portion.

4. The power transmission interruption apparatus according to claim 2, wherein the centrifugal hydraulic pressure canceller chamber is formed so as to include a fitting portion that is provided on the piston of the first hydraulic cylinder so as to be fitted to an outer peripheral side of the cylinder tube of the second hydraulic cylinder, wherein a sealing member that is provided in the fitting portion fluid-tightly seals between an inner peripheral surface of the fitting portion and an outer peripheral surface of the cylinder tube.

5. The power transmission interruption apparatus according to claim 2, wherein at least one of the first friction engaging device and the second friction engaging device is a multi plate device.

6. The power transmission interruption apparatus according to claim 2, wherein at least one of the first friction engaging device and the second friction engaging device is a single plate device.

7. The power transmission interruption apparatus according to claim 2, wherein a rotation may be selectively transmitted from the rotation member to the first connecting member and the second connecting member.

8. The power transmission interruption apparatus according to claim 2, wherein a rotation may be selectively transmitted from the second connecting member and the first connecting member to the rotation member.

9. The power transmission interruption apparatus according to claim 2, wherein a direction in which power is transmitted may be switched between a direction from the rotation member to the first connecting member and the second connecting member, and a direction from the second connecting member and the first connecting member to the rotation member, according to a condition.

10. The power transmission interruption apparatus according to claim 2, wherein at least one of the first connecting member and the second connecting member rotates around the axis.

11. The power transmission interruption apparatus according to claim 2, further comprising a housing which can fix at least one of the first connecting member and the second connecting member so as to prevent a rotation thereof.

12. The power transmission interruption apparatus according to claim 2, wherein the first connecting member and the second connecting member are separate from each other, and are rotatable with respect to each other.

13. The power transmission interruption apparatus according to claim 2, wherein the first connecting member and the second connecting memberare integrally assembled, and are constrained to rotate together.

14. The power transmission interruption apparatus according to claim 2, wherein a direction in which the piston of the second hydraulic cylinder is moved is the same as a direction in which the piston of the first hydraulic cylinder is moved.

15. The power transmission interruption apparatus according to claim 2, wherein a direction in which the piston of the second hydraulic cylinder is moved is opposite to a direction in which the piston of the first hydraulic cylinder is moved.

16. A power transmission interruption apparatus in which a pair of hydraulic cylinders, each of which causes each of a pair of friction engaging devices to be engaged, is provided coaxially and integrally with a common rotation member, is provided next to each other along to a rotation axis of the common rotation member, and is integrally rotated around the axis together with the rotation member, wherein a centrifugal hydraulic pressure canceller chamber is formed between a cylinder tube of one of the pair of hydraulic cylinders and a piston of the other hydraulic cylinder using the cylinder tube as a cancel plate, and the centrifugal hydraulic pressure canceller chamber cancels centrifugal hydraulic pressure in the other hydraulic cylinder, which is generated when hydraulic fluid is introduced into the other hydraulic cylinder.
